(19) United States
(12) Patent Application Publication
(10) Pub. No.: US 2010/0051215 A1
(43) Pub. Date: Mar. 4, 2010

(54) Insulative Window Covering (Light and/or Heat in single or multilayer manifestations)

(76) Inventor: Cole Wayne Rhoten, Loveland, OH (US)

Correspondence Address: Cole Rhoten, 6256 Hunterwood ln, Loveland, OH, 45140, US

(21) Appl. No.: 12/202,198

(22) Filed: Aug. 29, 2008

(51) Int. Cl. E06B 9/00

(52) U.S. Cl. 160/405

(57) ABSTRACT

A window may be made insulative through the addition of sealed, properly suited coverings. Window coverings are commonly considered blinds, but they are no longer restricted to only blocking the passage of light into a room. Blocking heat passage with a movable item (open/close), such as a window covering, allows a home or business owner to reap the benefits of high efficiency (insulative) windows without the expense. Multiple layers can be integrated into the system to give immense flexibility to the user; allowing solar light to fill a room while restricting heat (reducing summer air conditioning and lighting loads), restricting light and heat passage (dark room or theater conditions) or restricting light passage while allowing heat passage (dark room with comfortable outside temperature). The remaining option (free light and heat passage) is accomplished by any or all layers to expose the glass surface.

### FIELD OF THE INVENTION

The invention in question relates to the field of building materials, as a form of insulation in homes and buildings.

### BACKGROUND OF THE INVENTION

A large percentage of total energy consumption of an industrialized nation is relegated to temperature control of occupied structures. Insulation, of any form, reduces the amount of energy to maintain any given temperature within a structure.

Windows are often the most expensive (per unit area) to insulate and, even if of the most expensive breed, are often less insulative than the walls that surround it. To insulate the portion of a wall containing a window, without changing the window pane itself, is a potentially desirable method of accomplishing two, seemingly contradictory goals; both proper insulation and providing an unobstructed, fully functional pane of glass.

### DESCRIPTION OF THE PREFERRED EMBODIMENT

The following is a description of a single embodiment of the given invention. In no way is the inventor limiting the preceding invention through the statement of a specific embodiment.

The preceding may be manifest in an office building with the intention of minimizing operating costs (installation could potentially be justified by this fact). Sensors may determine lighting and temperature conditions (in a sample room, each room or upon the building) provoking the actuation of one or multiple layers of the window covering to be put in place. The covering could be mounted in a simple track along the length of a window, allowed to crease in an appealing manner or be placed onto a roll above or below a window.

The preceding may be manifest in a household as a user initiated device with a simple (conventional) rope for the selection of the desired covering, to be lowered in its track to serve its intended function.

1. A Window covering that creates a barrier, sealed to air when in place, separating the glass of the window and the interior volume of the room.

2. The apparatus of claim 1 may contain multiple layers applicable to differing circumstances. These layers may include, but are not limited to, window coverings that provide insulation against heat loss/gain while allowing light passage, insulating against heat loss/gain while blocking light passage and insulating against the passage of light while allowing free passage of heat.

3. The apparatus of claim 2, in which, common materials, not normally considered as insulative against the passage of light or heat may be tested for these properties and used in this manifestation. Common materials considered but not limited to, fabrics (natural and man made threads), plastics, rubbers, papers and various other materials not listed but potentially suited to the application in question.
